(19) United States
(12) Patent Application Publication
(10) Pub. No.: US 2023/0084723 A1
(43) Pub. Date: Mar. 16, 2023

(54) OPTICAL INTERFERENCE RANGE SENSOR

(71) Applicant: OMRON Corporation, Kyoto-shi (JP)

(72) Inventors: Masayuki HAYAKAWA, Kyoto-shi (JP); Kazuya KIMURA, Kyoto-shi (JP); Yusuke NAGASAKI, Kyoto-shi (JP)

(73) Assignee: OMRON Corporation, Kyoto-shi (JP)

(21) Appl. No.: 17/893,242

(22) Filed: Aug. 23, 2022

(30) Foreign Application Priority Data
Sep. 15, 2021 (JP) 2021-150066

(51) Int. Cl. G01S 17/08

(52) U.S. Cl. CPC G01S 17/08

(57) ABSTRACT

A light source projects a light beam while continuously varying a wavelength thereof. An interferometers generates an interference beam by interference between a measurement beam reflected at a measurement target as a result of a supplied light beam and a reference beam passing through an optical path that is at least partially different from an optical path of the measurement beam. A stages of optical couplers connected in series, each of the stages of optical couplers that receives the light beam from the light source, splits the received light beam into a beam proceeding to a corresponding interferometer and a beam proceeding to a downstream side, and supplies the split light beams. A suppressing unit suppresses a supply of a light beam from the downstream side to the upstream side. A processing unit calculates distance to the measurement target based on frequencies of an interference beams generated by the interferometers.

### CROSS-REFERENCES TO RELATED APPLICATIONS

This application claims priority to Japanese Patent Application No. 2021-150066 filed on Sep. 15, 2021, the entire contents of which are incorporated herein by reference.

### FIELD

The present disclosure relates to an optical interference range sensor.

### BACKGROUND

In recent years, optical range sensors that contactlessly measure the distance to a measurement target have been widely used. For example, known optical range sensors include optical interference range sensors that generate an interference beam by interference between a reference beam and a measurement beam from a light beam projected from a wavelength-swept light source and measure the distance to a measurement target based on the interference beam.

Particularly from the viewpoint of improving measurement accuracy, a multi-stage optical interference range sensor equipped with a plurality of interferometers that generate interference beams is known. For example, WO 2019/131298A discloses an optical interference tomographic imaging device that includes a light beam controller, a splitting unit that splits a plurality of light beams from the light beam controller into object beams and reference beams, a radiation unit that radiates a plurality of object beams toward a measurement target, and an interference unit that causes the object beams scattered from the measurement target to interfere with the reference beams and guides the beams to a light receiver.

An optical interference range sensor that splits light beams without using high-cost members such as a circulator is disclosed in the text entitled “Optical Frequency-Modulated Continuous-Wave (FMCW) Interferometry” by Zheng (“Zheng”), Springer, Jan. 4, 2005, p. 154. In other words, Zheng discloses an optical interference range sensor that includes a wavelength-swept light source, a plurality of optical couplers, a plurality of interferometers corresponding to respective optical couplers, and a light-receiving unit. Zheng discloses that the plurality of optical couplers included in the optical interference range sensor are connected in series. Zheng further discloses that a part of a light beam from the wavelength-swept light source is sequentially supplied from a previous-stage optical coupler to a next-stage coupler, and the other part of the light beam is split and supplied to the interferometers corresponding to the respective optical couplers.

WO 2019/131298A is an example of background art.

“Optical Frequency-Modulated Continuous-Wave (FMCW) Interferometry” by Jesse Zheng, Springer, Jan. 4, 2005, p. 154 is another example of background art.

### SUMMARY

However, a return beam from the downstream side to the upstream side may occur in a configuration in which each of the plurality of optical couplers connected in series splits a light beam into beams proceeding to the respective interferometers. Therefore, the measurement accuracy may deteriorate.

One or more embodiments aims to provide an optical interference range sensor in which return beams between optical couplers are suppressed, thereby improving measurement accuracy.

An optical interference range sensor according to one or more embodiments includes: a light source configured to project a light beam while continuously varying a wavelength thereof; a plurality of interferometers each configured to generate an interference beam by interference between a measurement beam reflected at a measurement target as a result of a supplied light beam being guided to the measurement target and a reference beam passing through an optical path that is at least partially different from an optical path of the measurement beam; a plurality of stages of optical couplers connected in series, each of the plurality of stages of optical couplers being configured to receive, from an upstream side, the light beam from the light source, split the received light beam into a beam proceeding to a corresponding interferometer, of the plurality of interferometers, and a beam proceeding to a downstream side, and supply the split light beams; a suppressing unit configured to suppress a supply of a light beam from the downstream side to the upstream side in the plurality of stages of optical couplers; and a processing unit configured to calculate a distance to the measurement target based on frequencies of a plurality of interference beams generated by the plurality of interferometers.

According to one or more embodiments, the supply of a light beam from the downstream side to the upstream side is suppressed in the plurality of stages of optical couples. Therefore, the measurement accuracy of the optical interference range sensor may be improved by suppressing return beams between the optical couplers.

In one or more embodiments, the suppressing unit may include at least one optical coupler out of the plurality of stages of optical couplers, the at least one optical coupler being configured to cause an amount of light of a light beam that is split and proceeds to the downstream stage to be larger than an amount of light of a light beam that is split and proceeds to the corresponding interferometer.

According to one or more embodiments, the supply of a light beam from the downstream side to the upstream side is suppressed in the plurality of stages of optical couplers. Therefore, the measurement accuracy of the optical interference range sensor may be improved by suppressing light beams returning from the next-stage optical coupler to the previous-stage optical coupler.

In one or more embodiments, a proportion, denoted by Rᵢ, of an amount of light of a light beam that is split and proceeds to the corresponding interferometer to an amount of light of a light beam that is split and proceeds to the downstream side, regarding an ith-stage optical coupler out of the plurality of stages of optical couplers may be set such that the expression Rᵢ₊₁≥Rᵢ is satisfied.

According one or more embodiments, variation in the amount of received light between the interferometers is reduced, thus making it possible to improve the measurement accuracy of the optical interference range sensor.

In one or more embodiments, the interferometers may generate the interference beam by interference between a first reflected beam that is a reflected beam of the measurement beam radiated toward the measurement target and reflected at the measurement target and a second reflected beam that is a reflected beam of the reference beam reflected at a reference surface.

According to the present embodiment or embodiments, each interference beam is generated by interference between the first reflected beam that is the measurement beam radiated toward the measurement target and reflected at the measurement target and the second reflected beam that is the reference beam reflected at the reference surface. The optical path length difference between the measurement beam and the reference beam is made different among the light beams that are split in correspondence with the plurality of spots. As a result, peaks may be appropriately detected, and the distance to the measurement target may be calculated with high accuracy based on the distance values corresponding to the detected peaks.

In one or more embodiments, an optical path length, denoted by L_{CR,i}, from an ith-stage optical coupler to a reference surface in a corresponding interferometer and an optical path length, denoted by L_{CC,i}, from the ith-stage optical coupler to an i+1th-stage optical coupler may be set such that the expression |L_{CR,i}−(L_{CR,i+1}+L_{CC,i})| is not smaller than a first threshold.

According to one or more embodiments, interference between the plurality of interference beams generated by the plurality of interferometers is suppressed, thereby making it possible to improve the measurement accuracy of the optical interference range sensor.

In one or more embodiments, the first threshold may be set based on a frequency band of a light-receiving unit configured to convert the plurality of interference beams into electrical signals and supply the electrical signals to the processing unit.

According to one or more embodiments, it is possible to effectively suppress interference between a plurality of interfering beams in accordance with the frequency band of the light-receiving unit, and to improve the measurement accuracy of the optical interference range sensor.

In one or more embodiments, the suppressing unit may include a cut-off unit, such as an isolator, connected between two optical couplers out of the plurality of stages of optical couplers and configured to guide a light beam from a previous-stage optical coupler to a next-stage optical coupler and not to guide a light beam from the next-stage optical coupler to the previous-stage optical coupler.

According to one or more embodiments, return beams from the next-stage optical coupler to the previous-stage optical coupler may be suppressed, thus making it possible to improve the measurement accuracy of the optical interference range sensor.

In one or more embodiments, an optical path length, denoted by L_{CR,I}, from an ith-stage optical coupler to a reference surface in a corresponding interferometer and an optical path length, denoted by L_{CI,I}, from the ith-stage optical coupler to the cut-off unit (isolator) connected thereto on a downstream side may be set such that the expression |L_{CR,I}−L_{CI,i}| is not smaller than a second threshold.

According to one or more embodiments, interference between reflected beams from the cut-off unit and the interference beams generated by the interferometers is suppressed, thus making it possible to improve the measurement accuracy of the optical interference range sensor.

In one or more embodiments, the second threshold may be set based on a frequency band of a light-receiving unit configured to convert the plurality of interference beams into electrical signals and supply the electrical signals to the processing unit.

According to one or more embodiments, it may be possible to effectively suppress reflected beams from the cut-off unit and the interference beams generated by the interferometers in accordance with the frequency band of the light-receiving unit, thus making it possible to improve the measurement accuracy of the optical interference range sensor.

According to one or more embodiments , an optical interference range sensor in which return beams between optical couplers are suppressed to improve measurement accuracy may be provided.

### BRIEF DESCRIPTION OF THE DRAWINGS

FIG. 1 is a schematic diagram illustrating an external appearance of an outline of a displacement sensor according to one or more embodiments.

FIG. 2 is a flowchart illustrating a procedure for measuring a measurement target with use of a displacement sensor according to one or more embodiments.

FIG. 3 is a functional block diagram illustrating an overview of a sensor system that uses a displacement sensor according to one or more embodiments.

FIG. 4 is a flowchart illustrating a procedure for measuring a measurement target with use of a sensor system that uses a displacement sensor according to one or more embodiments.

FIG. 5A is a diagram illustrating a principle by which a displacement sensor according to one or more embodiments measures a target object. FIG. 5B is a diagram illustrating another principle by which a displacement sensor according to one or more embodiments measures a measurement target.

FIG. 6A is a diagram illustrating a perspective view of a schematic configuration of a sensor head.

FIG. 6B is a diagram illustrating a perspective view of a schematic configuration of a collimating lens holder arranged within a sensor head.

FIG. 6C is a diagram illustrating a cross-sectional view of an internal structure of a sensor head.

FIG. 7 is a block diagram illustrating signal processing performed by a controller.

FIG. 8 is a flowchart illustrating a method for calculating a distance to a measurement target that is executed by a processing unit of a controller.

FIG. 9A a diagram illustrating how a waveform signal (voltage vs time) is subjected to frequency conversion into a spectrum (voltage vs frequency).

FIG. 9B a diagram illustrating how a spectrum (voltage vs frequency) is subjected to distance conversion into a spectrum (voltage vs distance).

FIG. 9C a diagram illustrating how a value (distance, SNR) corresponding to a peak is calculated based on a spectrum (voltage vs distance).

FIG. 10 is a schematic diagram illustrating a schematic configuration of an optical interference range sensor according to a first embodiment.

FIG. 11 is a schematic diagram illustrating an overview of a configuration of an optical interference range sensor according to a second embodiment

FIGS. 12A, 12B and 12C are diagrams illustrating variations of interferometers that generate an interference beam using a measurement beam and a reference beam.

### DETAILED DESCRIPTION

One or more embodiments will be described in detail with reference to the attached drawings. Note that the following embodiments are only for giving specific examples for carrying out one or more embodiments , and are not intended to interpret one or more embodiments in a limited manner. To facilitate understanding of the description, the same constituent elements in the drawings are assigned the same signs to the extent possible, and redundant descriptions may be omitted.

### Summary of Displacement Sensor

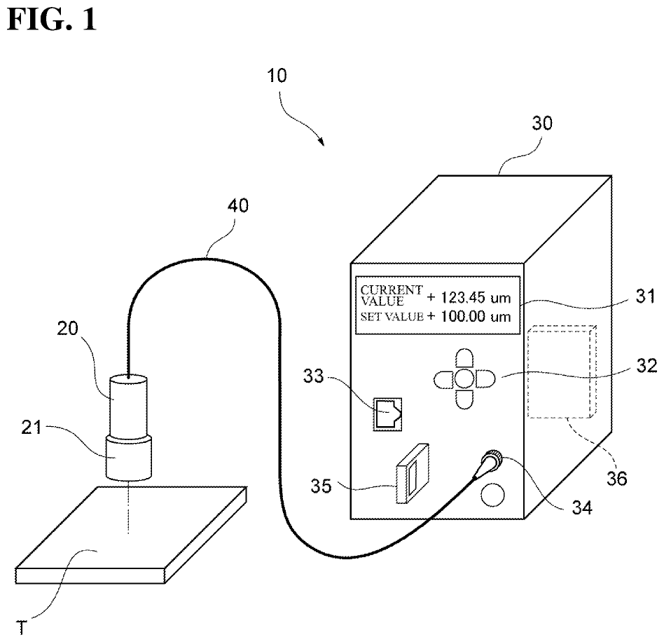

Firstly, a summary of a displacement sensor according to the present disclosure will be described. FIG. 1 is a schematic diagram of an external appearance showing an outline of a displacement sensor 10 according to the present disclosure. As shown in FIG. 1, the displacement sensor 10 includes a sensor head 20 and a controller 30, and measures displacement of a measurement target T (distance to the measurement target T).

The sensor head 20 and the controller 30 are connected by an optical fiber cable 40. An objective lens 21 is attached to the sensor head 20. The controller 30 includes a display unit 31, a setting unit 32, an external interface (I/F) unit 33, an optical fiber cable connector 34, and an external storage unit 35, and also contains a measurement processing unit 36.

The sensor head 20 radiates a light beam output from the controller 30 toward the measurement target T, and receives a reflected beam from the measurement target T. The sensor head 20 contains reference surfaces for reflecting a light beam that is output from the controller 30 and received via the optical fiber cable 40 and causing the reflected beam to interfere with the aforementioned reflected beam from the measurement target T.

Note that the objective lens 21 attached to the sensor head 20 is removable. The objective lens 21 can be replaced by another objective lens having an appropriate focal length in accordance with the distance between the sensor head 20 and the measurement target T. Alternatively, a variable-focus objective lens may be used.

Furthermore, when the sensor head 20 is installed, a guide beam (visible light) may be radiated toward the measurement object T, and the sensor head 20 and/or the measurement object T may be placed so that the measurement object T is appropriately positioned within a measurement area of the displacement sensor 10.

The optical fiber cable 40 is connected to the optical fiber cable connector 34 arranged on the controller 30 and connects the controller 30 to the sensor head 20. The optical fiber cable 40 thus guides a light beam projected from the controller 30 to the sensor head 20 and also guides return beams from the sensor head 20 to the controller 30. Note that the optical fiber cable 40 can be attached to and detached from the sensor head 20 and the controller 30, and may be an optical fiber with any of various lengths, thicknesses, and characteristics.

The display unit 31 is a liquid crystal display, an organic EL display, or the like, for example. The display unit 31 displays set values for the displacement sensor 10, the amount of light of return beams from the sensor head 20, and measurement results such as displacement of the measurement target T (distance to the measurement target T) measured by the displacement sensor 10.

The setting unit 32 allows a user to operate a mechanical button or a touch panel, for example, to configure settings necessary for measuring the measurement target T. Some or all of these necessary settings may be configured in advance, or may be configured from an externally connected device (not shown) that is connected to the external I/F unit 33. The externally connected device may be connected by wire or wirelessly via a network.

Here, the external I/F unit 33 is constituted by, for example, Ethernet (registered trademark), RS232C, analog output, or the like. The external I/F unit 33 may be connected to another connection device so that necessary settings are configured from the externally connected device, and may also output the results of measurement performed by the displacement sensor 10 to the externally connected device, for example.

Further, settings necessary for measuring the measurement target T may also be configured by the controller 30 retrieving data stored in the external storage unit 35. The external storage unit 35 is an auxiliary storage device such as a USB (Universal Serial Bus) memory. Settings or the like necessary for measuring the measurement target T are stored therein in advance.

The measurement processing unit 36 in the controller 30 includes, for example, a wavelength-swept light source that projects a light beam while continuously varying the wavelength, light-receiving elements that receive return beams from the sensor head 20 and convert the received beams to an electrical signal, a signal processing circuit that processes the electrical signal, and the like. The measurement processing unit 36 performs various processes using a controller, a storage, and the like based on return beams from the sensor head 20 so that the displacement of the measurement target T (distance to the measurement target T) is ultimately calculated. The details of the processing will be described later.

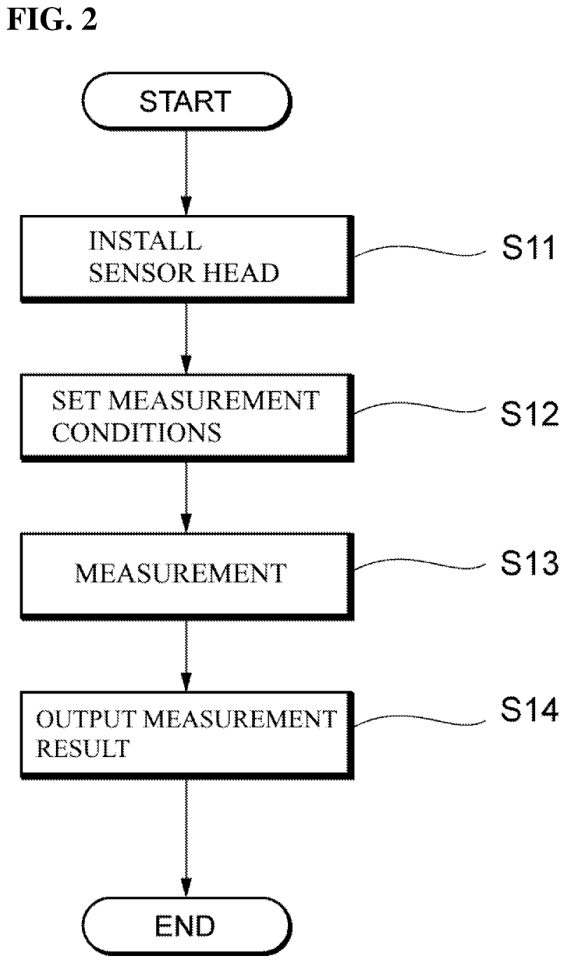

FIG. 2 is a flowchart showing a procedure for measuring a measurement target T with use of the displacement sensor 10 according to the present disclosure. The procedure includes steps S11 to S14, as shown in FIG. 2.

In step S11, the sensor head 20 is installed. For example, a guide beam is radiated from the sensor head 20 toward the measurement target T, and the sensor head 20 is installed at an appropriate position while referencing the radiated guide light.

Specifically, the amount of light of return beams received from the sensor head 20 may be displayed in the display unit 31 in the controller 30. The user may also adjust the orientation of the sensor head 20, the distance (height position) to the measurement target T, or the like while checking the amount of received light. Basically, if the light beam from the sensor head 20 is radiated more vertically (at an angle closer to vertical) relative to the measurement target T, the amount of light of reflected beams from the measurement target T becomes larger, and the amount of light of return beams received from the sensor head 20 also becomes larger.

The objective lens 21 may also be replaced with one having an appropriate focal length in accordance with the distance between the sensor head 20 and the measurement target T.

If appropriate settings cannot be configured (e.g., a necessary amount of received light for measurement cannot be obtained, or the focal length of the objective lens 21 is inappropriate etc.) when the measurement target T is measured, the user may be notified by displaying an error message, an incomplete setting message, or the like in the display unit 31 or outputting such a message to the externally connected device.

In step S12, various measurement conditions are set to measure the measurement target T. For example, the user sets unique calibration data (function etc. for correcting linearity) that the sensor head 20 has by operating the setting unit 32 in the controller 30.

Various parameters may also be set. For example, the sampling time, the measurement range, a threshold for determining whether to regard measurement results as normal or abnormal, or the like are set. Further, a measurement period may be set in accordance with characteristics of the measurement target T, such as the reflectance and material of the measurement target T, and a measurement mode or the like corresponding to the material of the measurement target T may also be set.

Note that these measurement conditions and various parameters are set by operating the setting unit 32 in the controller 30, but may alternatively be set from the externally connected device or may be set by retrieving data from the external storage unit 35.

In step S13, the measurement target T is measured with the sensor head 20 installed in step S11 in accordance with the measurement conditions and various parameters that are set in step S12.

Specifically, in the measurement processing unit 36 in the controller 30, the wavelength-swept light source projects a light beam, the light-receiving elements receive return beams from the sensor head 20, the signal processing circuit performs, for example, frequency analysis, distance conversion, peak detection, and the like to calculate displacement of the measurement target T (distance to the measurement target T). The details of specific measurement processing will be described later.

In step S14, the result of measurement in step S13 is output. For example, the displacement of the measurement target T (distance to the measurement target T) or the like measured in step S13 is displayed in the display unit 31 in the controller 30 or output to the externally connected device.

In addition, whether the displacement of the measurement target T (distance to the measurement target T) measured in step S13 is in a normal range or is abnormal based on the threshold set in step S12 may also be displayed or output as a measurement result. Furthermore, the measurement conditions, various parameters, the measurement mode, or the like that are set in step S12 may also be displayed or output together.

### Overview of System Iding Displacement Sensor

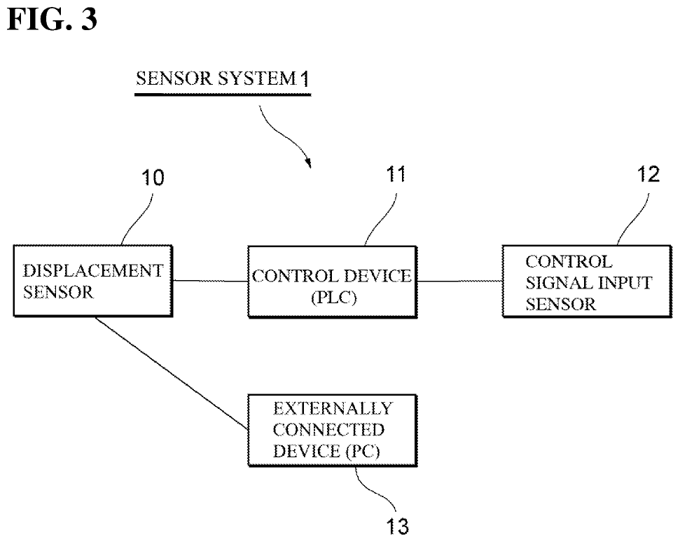

FIG. 3 is a functional block showing an overview of a sensor system 1 that uses the displacement sensor 10 according to the present disclosure. The sensor system 1 includes the displacement sensor 10, a control device 11, a control signal input sensor 12, and an externally connected device 13, as shown in FIG. 3. Note that the displacement sensor 10 is connected to the control device 11 and the externally connected device 13 by a communication cable or an external connection code (which may include an external input line, an external output line, a power line, etc.), for example. The control device 11 and the control signal input sensor 12 are connected by a signal line.

The displacement sensor 10 measures displacement of the measurement target T (distance to the measurement target T), as described with reference to FIGS. 1 and 2. The displacement sensor 10 may also output the measurement results or the like to the control device 11 and the externally connected device 13.

The control device 11 is a PLC (Programmable Logic Controller), for example, and gives the displacement sensor 10 various instructions when the displacement sensor 10 measures the measurement target T.

For example, the control device 11 may output a measurement timing signal to the displacement sensor 10 based on an input signal from the control signal input sensor 12 connected to the control device 11, and may also output a zero-reset command signal (a signal for setting a current measurement value to 0) or the like to the displacement sensor 10.

The control signal input sensor 12 outputs, to the control device 11, an on/off signal to indicate the timing for the displacement sensor 10 to measure the measurement target T. For example, the control signal input sensor 12 may be installed near a production line in which the measurement target T moves, and may output the on/off signal to the control device 11 in response to detecting that the measurement target T has moved to a predetermined position.

The externally connected device 13 is a PC (Personal Computer), for example. The user can configure various setting to the displacement sensor 10 by operating the externally connected device 13.

As a specific example, the measurement mode, the work mode, the measurement period, the material of the measurement target T, and the like are set.

An “internally synchronized measurement mode”, in which measurement periodically starts within the control device 11, or an “externally synchronized measurement mode”, in which measurement starts in response to an input signal from outside the control device 11, or the like can be selected as a setting of the measurement mode.

An “operation mode”, in which the measurement target T is actually measured, an “adjustment mode”, in which measurement conditions for measuring the measurement target T are set, or the like can be selected as a work mode setting.

The “measurement period” refers to a period for measuring the measurement target T and may be set in accordance with the reflectance of the measurement target T. Even if the measurement target T has a low reflectance, the measurement target T can be appropriately measured by lengthening the measurement period to set an appropriate measurement period.

As a mode for the measurement target T, a “rough surface mode”, which is suitable when the components of the reflected beam reflected from the measurement target T include a relatively large diffuse reflection, a “specular mode”, which is suitable when the components of the reflected beam include a relatively large specular reflection, an intermediate “standard mode”, or the like can be selected.

Thus, the measurement target T can be measured with higher accuracy by configuring appropriate settings in accordance with the reflectance and material of the measurement target T.

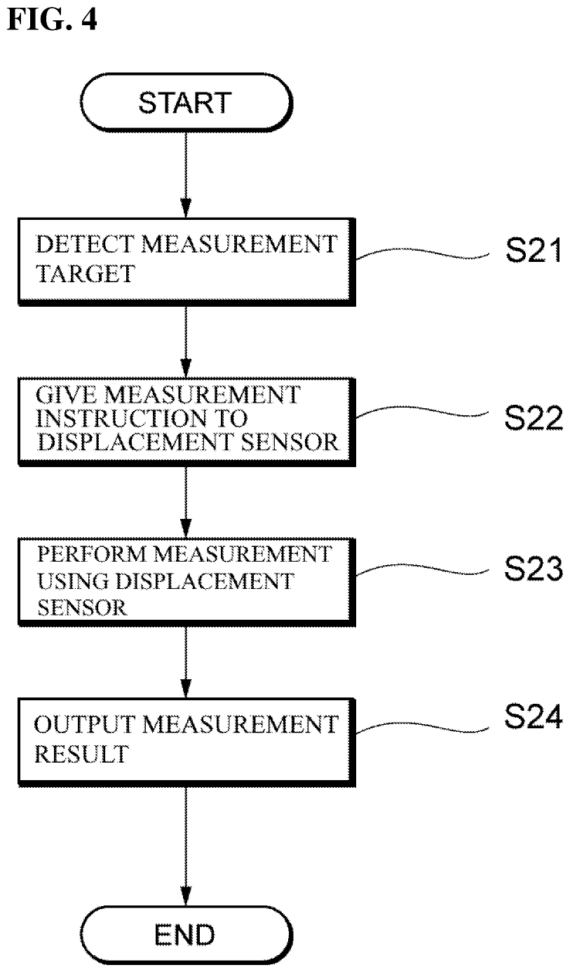

FIG. 4 is a flowchart showing a procedure for measuring the measurement target T with use of the sensor system 1 that uses the displacement sensor 10 according to the present disclosure. The procedure shown in FIG. 4, is for the case of the aforementioned externally synchronized measurement mode and includes steps S21 to S24.

In step S21, the sensor system 1 detects the measurement target T, which is an object to be measured. Specifically, the control signal input sensor 12 detects that the measurement target T has moved to a predetermined position on a production line.

In step S22, the sensor system 1 gives an instruction to measure the measurement target T detected in step S21, with use of the displacement sensor 10. Specifically, the control signal input sensor 12 indicates the timing of measuring the measurement target T detected in step S21 by outputting an on/off signal to the control device 11. The control device 11 outputs a measurement timing signal to the displacement sensor 10 based on the on/off signal to give an instruction to measure the measurement target T.

In step S23, the displacement sensor 10 measures the measurement target T. Specifically, the displacement sensor 10 measures the measurement target T based on the measurement instruction received in step S22.

In step S24, the sensor system 1 outputs the result of measurement in step S23. Specifically, the displacement sensor 10 causes the display unit 31 to display the result of measurement processing, and/or outputs the result to the control device 11, the externally connected device 13, or the like via the external I/F unit 33.

Note that the above description has been given, with reference to FIG. 4, of the procedure in the case of the externally synchronized measurement mode in which the measurement target T is measured upon the control signal input sensor 12 detecting the measurement target T. However, there is no limitation thereto. In the case of the internally synchronized measurement mode, for example, an instruction to measure the measurement target T is given to the displacement sensor 10 upon a measurement timing signal being generated based on a preset period, instead of steps S21 and S22.

Next, a description will be given of the principle by which the displacement sensor 10 according to the present disclosure measures the measurement target T.

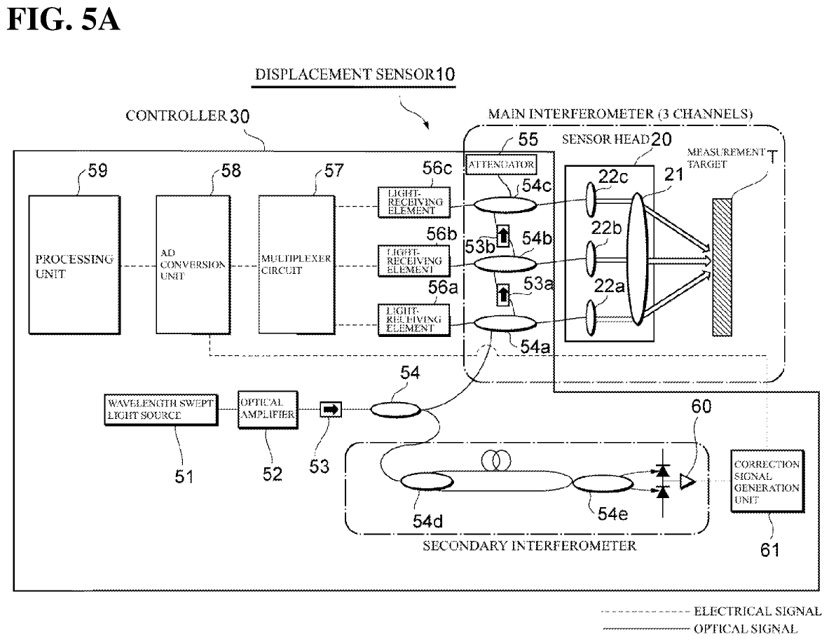

FIG. 5A is a diagram illustrating a principle by which the displacement sensor 10 according to the present disclosure measures a measurement target T. As shown in FIG. 5A, the displacement sensor 10 includes the sensor head 20 and the controller 30. The sensor head 20 includes the objective lens 21 and a plurality of collimating lenses 22a to 22c. The controller 30 includes a wavelength-swept light source 51, an optical amplifier 52, a plurality of isolators 53, 53a, and 53b, a plurality of optical couplers 54 and 54a to 54e, an attenuator 55, a plurality of light-receiving elements (e.g., photodetectors (PD)) 56a to 56c, a multiplexer circuit 57, an analog-to-digital (AD) conversion unit (e.g., analog-to-digital converter) 58, a processing unit (e.g., processor) 59, a balance detector 60, and a correction signal generation unit 61.

The wavelength-swept light source 51 projects a wavelength-swept laser beam. The wavelength-swept light source 51 can be realized at low cost by, for example, applying a method of modulating a VCSEL (Vertical Cavity Surface Emitting Laser) with current since mode hopping is unlikely to occur due to a short resonator length, and the wavelength can be easily varied.

The optical amplifier 52 amplifies the beam projected from the wavelength-swept light source 51. The optical amplifier 52 is an EDFA (erbium-doped fiber amplifier), for example, and may be an optical amplifier dedicated to 1550 nm, for example.

The isolator 53 is an optical element through which an incident light beam is unidirectionally transmitted, and may immediately follow the wavelength-swept light source 51 in order to prevent the effect of noise generated by return beams.

Thus, the light beam projected from the wavelength-swept light source 51 is amplified by the optical amplifier 52, passes through the isolator 53, and is split into beams proceeding to a main interferometer and a secondary interferometer by the optical coupler 54. For example, the optical coupler 54 may split the light beam into the beams proceeding to the main and secondary interferometers at a ratio of 90:10 to 99:1.

The light beam that is split and proceeds to the main interferometer is further split into a beam in a direction toward the sensor head 20 and a beam in a direction toward the second-stage optical coupler 54b by the first-stage optical coupler 54a.

The light beam that is split in the direction toward the sensor head 20 by the first-stage optical coupler 54a passes through the collimating lens 22a and the objective lens 21 from the leading end of an optical fiber cable in the sensor head 20, and is radiated toward the measurement target T. Then, a light beam reflected at a reference surface, which is the leading end (end face) of the optical fiber cable, interferes with a light beam reflected at the measurement target T, and an interference beam is generated. The generated interference beam returns to the first-stage optical coupler 54a, and is thereafter received by the light-receiving element 56a and converted into an electrical signal.

The light beam that is split in the direction toward the second-stage optical coupler 54b by the first-stage optical coupler 54a proceeds toward the second-stage optical coupler 54b via the isolator 53a, and is further split in a direction toward the sensor head 20 and a direction toward the third-stage optical coupler 54c by the second-stage optical coupler 54b. The light beam that is split in the direction toward the sensor head 20 from the optical coupler 54b passes through the collimating lens 22b and the objective lens 21 from the leading end of an optical fiber cable in the sensor head 20, as with the first stage, and is radiated toward the measurement target T. Then, a light beam reflected at a reference surface, which is the leading end (end face) of the optical fiber cable, interferes with a light beam reflected at the measurement target T, and an interference beam is generated. The generated interference beam returns to the second-stage optical coupler 54b, and is split into beams in a direction toward the isolator 53a and a direction toward the light-receiving element 56b by the optical coupler 54b. The light beam that is split in the direction toward the light-receiving element 56b from the optical coupler 54b is received by the light-receiving element 56b and converted into an electrical signal. Meanwhile, the isolator 53a is an example of a suppressing unit and a cut-off unit, and is configured to transmit a light beam from the previous-stage optical coupler 54a toward the latter-stage optical coupler 54b and cut off a light beam from the latter-stage optical coupler 54b toward the previous-stage optical coupler 54a. Therefore, the beam split in the direction toward the isolator 53a from the optical coupler 54b is cut off.

The light beam that is split in the direction toward the third-stage optical coupler 54c by the second-stage optical coupler 54b proceeds toward the third-stage optical coupler 54c via the isolator 53b, and is further split in the direction toward the sensor head 20 and a direction toward the attenuator 55 by the third-stage optical coupler 54c. The light beam that is split in the direction toward the sensor head 20 from the optical coupler 54c passes through the collimating lens 22c and the objective lens 21 from the leading end of an optical fiber cable in the sensor head 20, as with the first and second stages, and is radiated toward the measurement target T. Then, a light beam reflected at the leading end (end face) of the optical fiber cable, interferes with a light beam reflected at the measurement target T, and an interference beam is generated. The generated interference beam returns to the third-stage optical coupler 54c, and is split into beams in a direction toward the isolator 53b and a direction toward the light-receiving element 56c from the optical coupler 54c. The isolator 53b is an example of the suppressing unit, and suppresses the supply of a light beam from the latter-stage optical coupler 54c to the previous-stage optical coupler 54b. The light beam that is split in the direction toward the light-receiving element 56c from the optical coupler 54c is received by the light-receiving element 56c and converted into an electrical signal.

Note that the light beam that is split in the direction toward the attenuator 55 by the third-stage optical coupler 54c is not used to measure the measurement target T. Therefore, the light beam is attenuated so as not to be reflected and returned.

Thus, the main interferometer is an interferometer that has three stages of optical paths (three channels) each having an optical path length difference that is twice (round trip) the distance from the leading end (end face) of the optical fiber cable of the sensor head 20 to the measurement target T, and three interference beams corresponding to respective optical path length differences are generated.

The light-receiving elements 56a to 56c receive the interference beams from the main interferometer and generate electrical signals in accordance with the amount of light of the light beams received, as mentioned above.

The multiplexer circuit 57 multiplexes the electrical signals output from the light-receiving elements 56a to 56c.

The AD conversion unit 58 receives the electrical signal from the multiplexer circuit 57 and converts the electrical signal from an analog signal to a digital signal (AD conversion). Here, the AD conversion unit 58 performs AD conversion based on a correction signal from the correction signal generation unit 61 of the secondary interferometer.

The secondary interferometer obtains the interference signal in order to correct wavelength nonlinearities during the sweep with the wavelength-swept light source 51, and generates a correction signal called a K-clock.

Specifically, the light beam that is split and proceeds to the secondary interferometer by the optical coupler 54 is further split by the optical coupler 54d. Here, the optical paths of the split light beams are configured to have an optical path length difference using optical fiber cables with different lengths between the optical couplers 54d and 54e, and an interference beam corresponding to the optical path length difference is output from the optical coupler 54e, for example. The balance detector 60 receives the interference beam from the optical coupler 54e, and amplifies the optical signal and converts it to an electrical signal while removing noise by taking a difference from a signal of the opposite phase.

Note that the optical coupler 54d and the optical coupler 54e may split the light beam at a ratio of 50:50.

The correction signal generation unit 61 ascertains the wavelength nonlinearities during the sweep with the wavelength-swept light source 51 based on the electrical signal from the balance detector 60, generates a K-clock corresponding to the nonlinearities, and outputs the generated K-clock to the AD conversion unit 58.

Due to the wavelength nonlinearities during the sweep with the wavelength-swept light source 51, the wave intervals of the analog signal input to the AD conversion unit 58 from the main interferometer are not equal. The AD conversion unit 58 performs

AD conversion (sampling) while correcting the sampling time based on the aforementioned K-clock so that the wave intervals are equal intervals.

Note that the K-clock is a correction signal used to sample the analog signal of the main interferometer, as mentioned above. Therefore, the K-clock needs to be generated so as to have a higher frequency than the analog signal of the main interferometer. Specifically, the optical path length difference provided between the optical coupler 54d and the optical coupler 54e in the secondary interferometer may be longer than optical path length differences between the leading ends (end faces) of the optical fiber cables in the main interferometer and the measurement target T. Alternatively, the correction signal generation unit 61 may increase the frequency by multiplication (e.g., by a factor of 8, etc.).

The processing unit 59 obtains the digital signal that has been subjected to AD conversion with its nonlinearities corrected by the AD conversion unit 58, and calculates displacement of the measurement target T (distance to the measurement target T) based on the digital signal. Specifically, the processing unit 59 performs frequency conversion on the digital signal using fast Fourier transform (FFT), and calculates the distance by analyzing them. The details of processing at the processing unit 59 will be described later.

Note that the processing unit 59 is required to perform high-speed processing, and is therefore realized by an integrated circuit such as an FPGA (field-programmable gate array) in many cases.

Here, the multiplexer circuit 57 is arranged on the upstream side of the AD conversion unit 58, but may alternatively be arranged on the downstream side of the AD conversion unit 58. The output from the plurality of PDs 56a to 56c may be separately subjected to AD conversion and then multiplexed by the multiplexer circuit 57.

Also, here, three stages of optical paths are provided in the main interferometer. The sensor head 20 radiates measurement beams from the respective optical paths toward the measurement target T, and the distance to the measurement target T, for example, is measured based on interference beams (return beams) obtained from the respective optical paths (multichannel). The number of channels in the main interferometer is not limited to three, and may alternatively be one or two, or may be four or more.

FIG. 5B is a diagram illustrating another principle by which a displacement sensor 10 according to the present disclosure may measure the measurement target T. As shown in FIG. 5B, the displacement sensor 10 includes a sensor head 20 and a controller 30. The sensor head 20 includes an objective lens 21 and a plurality of collimating lenses 22a to 22c. The controller 30 includes a wavelength-swept light source 51, an optical amplifier 52, a plurality of isolators 53, 53a and 53b, a plurality of optical couplers 54 and 54a to 54j, an attenuator 55, a plurality of light-receiving elements (e.g., photodetectors (PD)) 56a to 56c, a multiplexer circuit 57, an analog-to-digital (AD) conversion unit (e.g., analog-to-digital converter) 58, a processing unit (e.g., processor) 59, a balance detector 60, and a correction signal generation unit 61. The displacement sensor 10 shown in FIG. 5B has a configuration different from that of the displacement sensor 10 shown in FIG. 5A mainly in that the former has the optical couplers 54f to 54j. A principle of the different configuration will be described in detail in comparison with FIG. 5A.

The light beam projected from the wavelength-swept light source 51 is amplified by the optical amplifier 52, and is split into a beam proceeding to the main interferometer side and a beam proceeding to the secondary interferometer side by the optical coupler 54 via the isolator 53. The light beam that is split and proceeds to the main interferometer side is further split into a measurement beam and a reference beam by the optical coupler 54f.

The measurement beam is caused to pass through the collimating lens 22a and the objective lens 21 by the first-stage coupler 54a and radiated to the measurement target T, and is reflected at the measurement target T, as described with reference to

FIG. 5A. Here, in FIG. 5A, the light beam reflected at the reference surface, which is the leading end (end face) of an optical fiber cable, interferes with the light beam reflected at the measurement target T, and an interference beam is generated. Meanwhile, in FIG. 5B, the reference surface that reflects the light beam is not provided. In other words, in FIG. 5B, the light that is reflected at the reference surface as in FIG.

5A is not generated in FIG. 5B, and therefore, the measurement beam reflected at the measurement target T returns to the first-stage optical coupler 54a.

Similarly, the light beam that is split in the direction toward the second-stage optical coupler 54b from the first-stage optical coupler 54a is caused to pass through the collimating lens 22b and the objective lens 21 by the second-stage optical coupler 54b and radiated toward the measurement target T, and is reflected at the measurement target T and returns to the second-stage optical coupler 54b. The light beam that is split in the direction toward the third-stage optical coupler 54c from the second-stage optical coupler 54b is caused to pass through the collimating lens 22c and the objective lens 21 by the third-stage optical coupler 54c and radiated toward the measurement target T, and is reflected at the measurement target T and returns to the third-stage optical coupler 54c.

Meanwhile, the reference beam split by the optical coupler 54f is further split into beams proceeding to the optical couplers 54h, 54i, and 54j by the optical coupler 54g.

In the optical coupler 54h, the measurement beam that has been reflected at the measurement target T and output from the optical coupler 54a interferes with the reference beam output from the optical coupler 54g, and an interference beam is generated. The generated interference beam is received by the light-receiving element 56a and converted into an electrical signal. In other words, a light beam is split into the measurement beam and the reference beam by the optical coupler 54f, an interference beam is generated in correspondence with the optical path length difference between the optical path of the measurement beam (an optical path in which the light beam from the optical coupler 54f is reflected at the measurement target T via the optical coupler 54a, the collimating lens 22a and the objective lens 21 and reaches the optical coupler 54h) and the optical path of the reference beam (an optical path in which the light beam from the optical coupler 54f reaches the optical coupler 54h via the optical coupler 54g).

Similarly, in the optical coupler 54i, an interference beam is generated in correspondence with the optical path length difference between the optical path of the measurement beam (an optical path in which the light beam from the optical coupler 54f is reflected at the measurement target T via the optical couplers 54a and 54b, the collimating lens 22b, and the objective lens 21 and reaches the optical coupler 54i) and the optical path of the reference beam (an optical path in which the light beam from the optical coupler 54f reaches the optical coupler 54i via the optical coupler 54g). The generated interference beam is received by the light-receiving element 56b and converted into an electrical signal.

In the optical coupler 54j, an interference beam is generated in correspondence with the optical path length difference between the optical path of the measurement beam (an optical path in which the light beam from the optical coupler 54f is reflected at the measurement target T via the optical couplers 54a, 54b, and 54c, the collimating lens 22c, and the objective lens 21 and reaches the optical coupler 54j) and the optical path of the reference beam (an optical path in which the light beam from the optical coupler 54f reaches the optical coupler 54j via the optical coupler 54g). The generated interference beam is received by the light-receiving element 56c and converted into an electrical signal.

Thus, the main interferometer has three stages of optical paths (three channels), and generates three interference beams corresponding to the respective optical path length differences between the measurement beams that are reflected at the measurement target T and input to the optical couplers 54h, 54i, and 54j and the reference beams that are input to the optical couplers 54h, 54i, and 54j via the optical couplers 54f and 54g.

Note that the optical path length difference between a measurement beam and a reference beam may also be set so as to be different among the three channels. For example, the optical path lengths from the optical coupler 54g may be different among the optical couplers 54h, 54i, and 54j.

The distance to the measurement target T or the like is measured based on the interference beams obtained from respective optical paths (multichannel).

### Configuration of Sensor Head

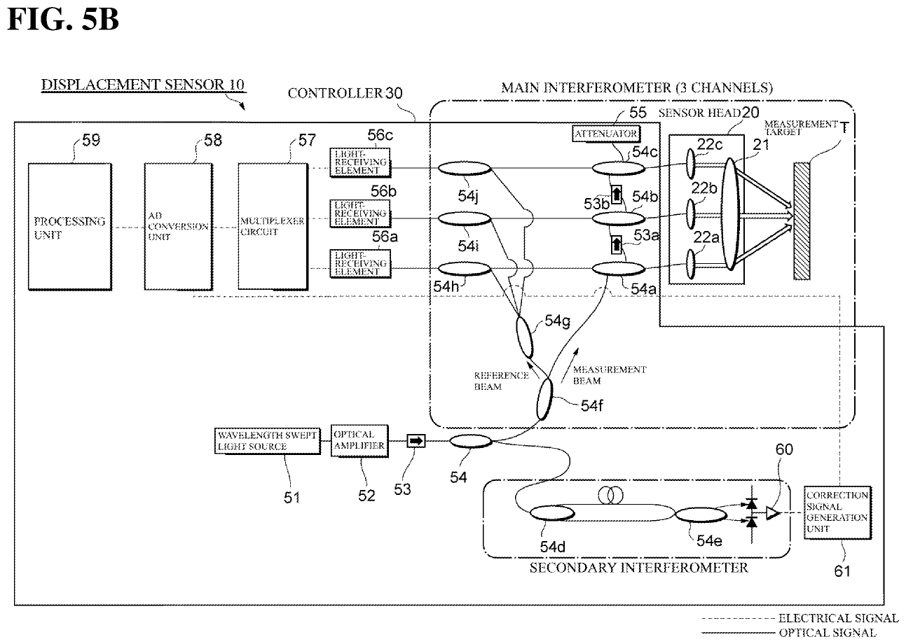

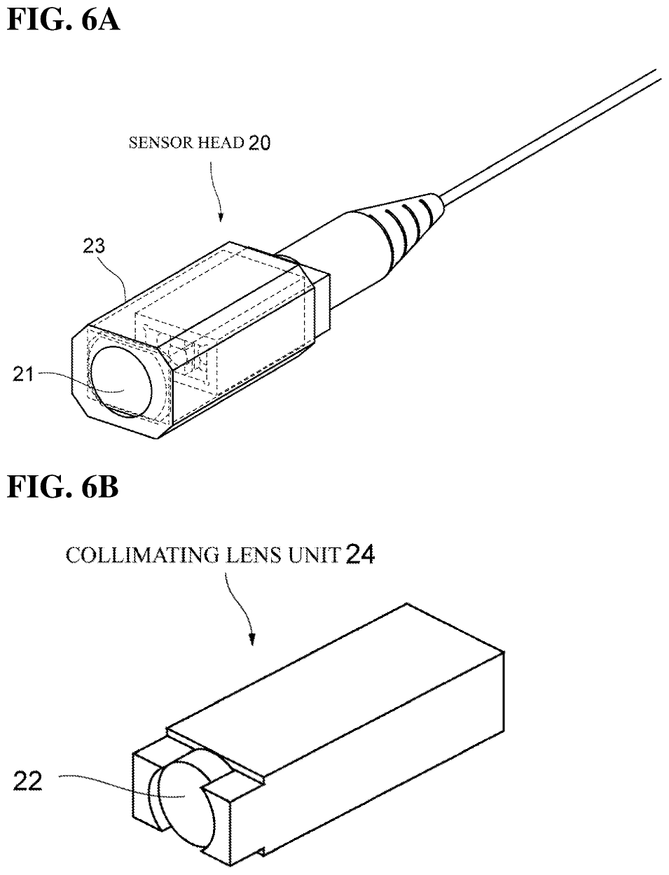

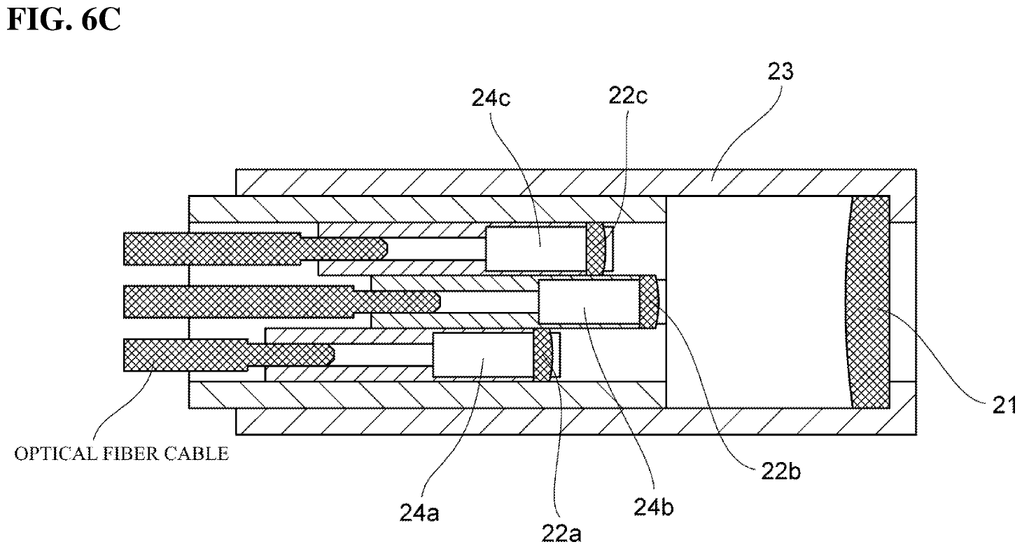

Here, a structure of the sensor head used in the displacement sensor 10 will be described. FIG. 6A is a perspective view showing a schematic configuration of the sensor head 20. FIG. 6B is a perspective view of a schematic configuration of a collimating lens holder arranged within the sensor head 20. FIG. 6C is a cross-sectional view of an internal structure of the sensor head.

In the sensor head 20, the objective lens 21 and the collimating lenses are accommodated in an objective lens holder 23, as shown in FIG. 6A. For example, the individual sides of the objective lens holder 23 that surround the objective lens 21 are about 10 mm long, and the objective lens holder 23 is about 22 mm in length in the optical axis direction.

As shown in FIG. 6B, a collimating lens unit 24 is formed by adhering a collimating lens 22 to the collimating lens holder using an adhesive material. The spot diameter can be adjusted by inserting an optical fiber cable, in accordance with the amount of insertion. The diameter of each collimating lens 22 is about 2 mm, for example.

Three collimating lenses 22a to 22c are held by the collimating lens holder, constituting collimating lens units 24a to 24c, and three optical fiber cables are inserted into the respective collimating lens units 24a to 24c in correspondence with the three collimating lenses 22a to 22c, as shown in FIG. 6C. Note that the three optical fiber cables may alternatively be held by the collimating lens holder.

These optical fiber cables and the collimating lens units 24a to 24c are held together with the objective lens 21 by the objective lens holder 23 and constitute the sensor head 20.

Here, the three collimating lens units are shifted with respect to each other so as to form different optical path length differences in terms of their positions in the optical axis direction in the sensor head 20, as shown in FIG. 6C.

The objective lens holder 23 and the collimating lens units 24a to 24c that constitute the sensor head 20 may be made of a metal (e.g., A2017) that has high strength and can be processed with high accuracy.

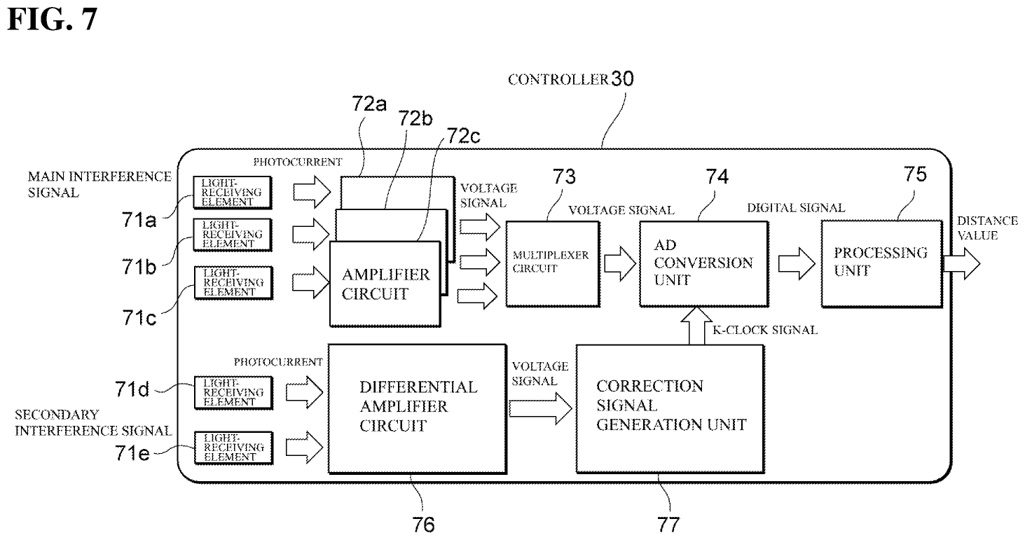

FIG. 7 is a block diagram illustrating signal processing in the controller 30. As shown in FIG. 7, the controller 30 includes a plurality of light-receiving elements 71a to 71e, a plurality of amplifier circuits 72a to 72c, a multiplexer circuit 73, an AD conversion unit 74, a processing unit 75, a differential amplifier circuit 76, and a correction signal generation unit 77.

In the controller 30, the light beam projected from the wavelength-swept light source 51 is split into a beam proceeding to the main interferometer and a beam proceeding to the secondary interferometer by the optical coupler 54, and the value of the distance to the measurement target T is calculated by processing main interference signals and secondary interference signals obtained respectively from the main and secondary interferometers, as illustrated in FIG. 5A.

The plurality of light-receiving elements 71a to 71c correspond to the light-receiving elements 56a to 56c shown in FIG. 5A, receive the main interference signals from the main interferometer, and output the received signals as current signals to the amplifier circuits 72a to 72c, respectively.

The plurality of amplifier circuits 72a to 72c convert the current signals to voltage signals (I-V conversion) and amplify these signals.

The multiplexer circuit 73 multiplexes the voltage signals output from the amplifier circuits 72a to 72c and outputs the multiplexed signal as one voltage signal to the AD conversion unit 74.

The AD conversion unit 74 corresponds to the AD conversion unit 58 shown in FIG. 5A, and converts the voltage signal to a digital signal (AD conversion) based on a K-clock from the later-described correction signal generation unit 77.

The processing unit 75 corresponds to the processing unit 59 shown in FIG. 5A, converts the digital signal from the AD conversion unit 74 to a frequency by means of FFT, analyzes the frequency, and calculates the value of the distance to the measurement target T.

The plurality of light-receiving elements 71d to 71e and the differential amplifier circuit 76, which correspond to the balance detector 60 shown in FIG. 5A, receive interference beams in the secondary interferometer, output interference signals one of which has an inverted phase, and amplify the interference signals and convert these signals to a voltage signal while removing noise by taking a difference between the two signals.

The correction signal generation unit 77 corresponds to the correction signal generation unit 61 shown in FIG. 5A, binarizes the voltage signal using a comparator, generates a K-clock, and outputs the generated K-clock to the AD conversion unit 74. The K-clock needs to be generated so as to have a higher frequency than the analog signal of the main interferometer. Therefore, the correction signal generation unit 77 may increase the frequency by multiplication (e.g., by a factor of 8 etc.).

Although the multiplexer circuit 73 in the controller 30 shown in FIG. 7 is arranged on the upstream side of the AD conversion unit 74, it may alternatively be arranged on the downstream side of the AD conversion unit 74. The output from the plurality of light-receiving elements 71a to 71c and the plurality of amplifier circuits 72a to 72c may be subjected to AD conversion, and may thereafter be multiplexed by the multiplexer circuit 73.

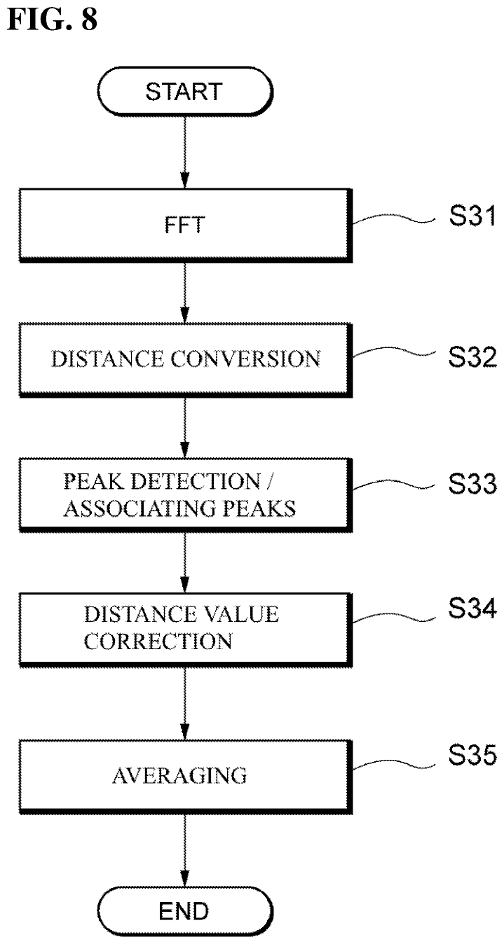

FIG. 8 is a flowchart showing a method for calculating the distance to the measurement target T that is executed by the processing unit 59 in the controller 30. The illustrated method includes steps S31 to S35, as shown in FIG. 8.

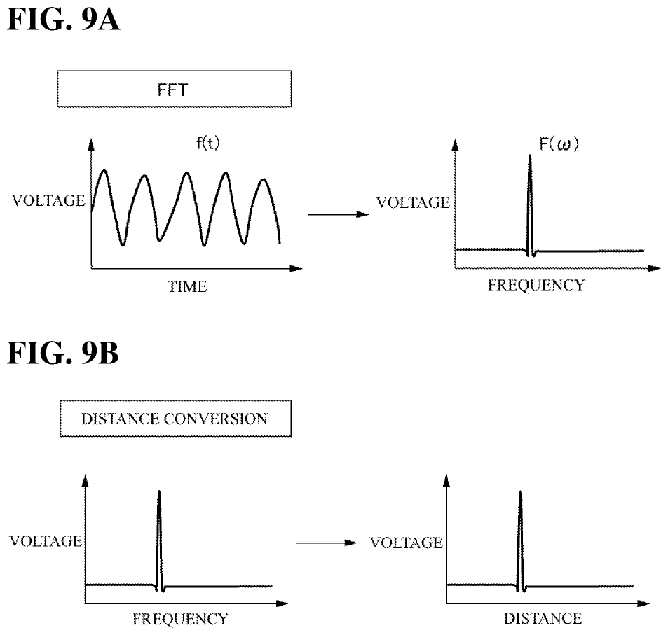

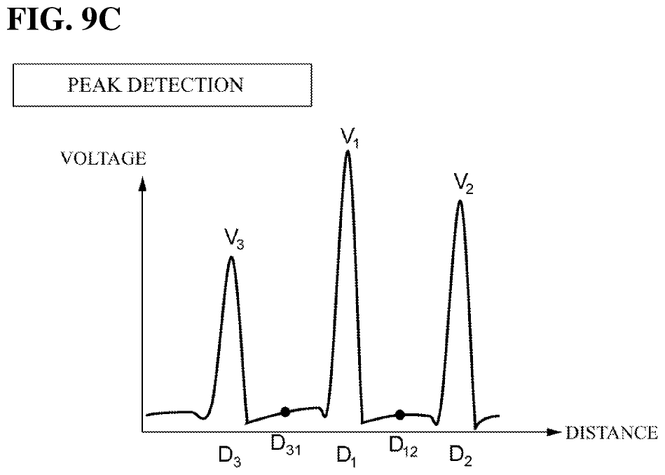

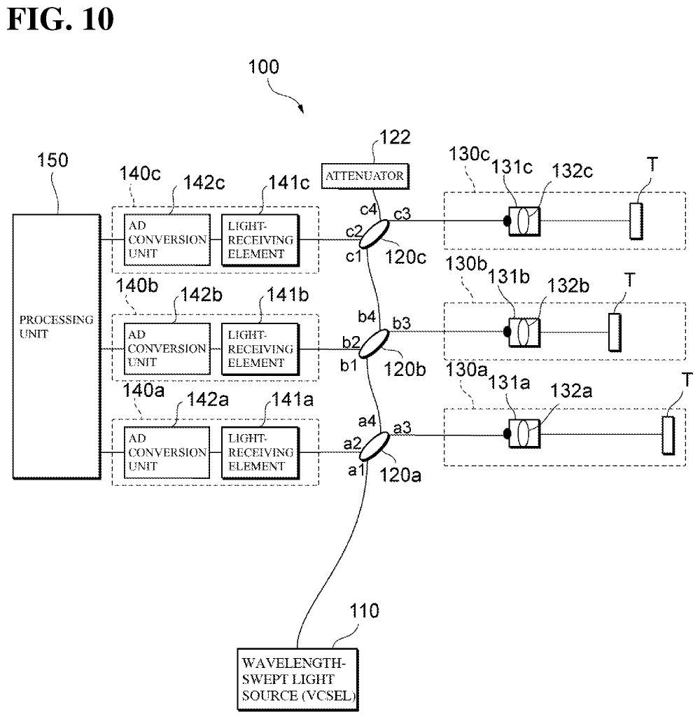

In step S31, the processing unit 59 performs frequency conversion on a waveform signal (voltage vs time) into a spectrum (voltage vs frequency) by means of a Fast Fourier Transform (FFT), such as according to the expression shown in Equation 1. FIG. 9A shows how the waveform signal (voltage vs time) is subjected to frequency conversion into the spectrum (voltage vs frequency).

$${\sum }_{t = 0}^{N - 1} f ( t ) exp ( - i \frac{2 πω t}{N} ) = F ( ω ) \qquad ( Equation 1 )$$

$$where N = Number of data points$$

In step S32, the processing unit 59 performs distance conversion on the spectrum (voltage vs frequency) into a spectrum (voltage vs distance). FIG. 9B shows how the spectrum (voltage vs frequency) is subjected to distance conversion into the spectrum (voltage vs distance).

In step S33, the processing unit 59 calculates values (distance value, SNR) corresponding to peaks based on the spectrum (voltage vs distance). FIG. 9C shows how the values (distance, SNR) corresponding to peaks are calculated based on the spectrum (voltage vs distance).

(1) Peak values of voltage are calculated. Specifically, pairs (Dx, Vx) of a distance value and a voltage value at a distance at which the differential value of the voltage goes from positive to negative are created with respect to the voltage shown in FIG. 9C, and are arranged in descending order of the voltage value, i.e., (D1, V1), (D2, V2), (D3, V3), . . . , (Dn, Vn) . .. and so on.

(2) Any combination with which the number of multiple heads is exceeded is excluded. For example, the displacement sensor 10 is provided with three stages of optical paths in the main interferometer, the sensor head 20 radiates measurement beams from the respective optical paths toward the measurement target T, and interference beams (return beams) obtained from the respective optical paths are received (the number of multiple heads=3), as shown in FIG. 5A. If there are four or more peaks, any peak in excess of three derives from noise, and may therefore be excluded from the calculation target. If the number of multiple heads is three, the pairs are (D1, V1), (D2, V2), and (D3, V3).

(3) The obtained pairs are rearranged in the order of distance. If the pairs are arranged in the ascending order of distance, they are arranged in the order of (D3, V3), (D1, V1), and (D2, V2).

(4) Peak-to-peak voltages are obtained. Specifically, a voltage V31 at an intermediate distance D31 between D3 and D1 is obtained, and a voltage V12 at an intermediate distance D12 between D1 and D2 is obtained. Then, an average voltage Vn of these voltages is calculated with an expression: Vn=(V31+V12)/2.

(5) Respective SNRs are calculated. Specifically, the following SNRs are obtained: SN1=V1/Vn, SN2=V2/Vn, and SN3=V3/Vn.

Thus, the values corresponding to the peaks are calculated as (distance value, SNR)=(D1, SN1), (D2, SN2), (D3, SN3) based on the spectrum (voltage vs. distance).

Returning to FIG. 8, in step S34, the processing unit 59 corrects the distance values out of the values (distance value, SNR) corresponding to the peaks that are calculated in step S33. Specifically, the three collimating lens units 24a to 24c (collimating lenses 22a to 22c and the optical fiber cables) are shifted from each other in terms of the position in the optical axis direction of the sensor head 20, as shown in FIG. 6C. Therefore, the distance values D1, D2, and D3 corresponding to the respective peaks are corrected in accordance with the shift amounts (e.g., h1, h2, h3 etc.).

As a result, the values corresponding to the peaks are calculated as (corrected distance value, SNR)=(D1+h1, SN1), (D2+h2, SN2), (D3+h3, SN3).

In step S35, the processing unit 59 averages the distance values out of the values corresponding to the peaks (corrected distance value, SNR) that are calculated in step S34. Specifically, it is favorable that the processing unit 59 averages those corrected distance values with an SNR that has at least a threshold value out of the values (corrected distance value, SNR) corresponding to the peaks, and outputs the result of the averaging calculation as the distance to the measurement object T.

Next, a specific embodiment of the present disclosure will be described in detail, focusing on more characteristic configurations, functions, and properties. Note that the following optical interference range sensor corresponds to the displacement sensor 10 described with reference to FIGS. 1 to 9. Some or all of the basic configurations, functions, and properties included in the present optical interference range sensor are common to the configurations, functions, and properties included in the displacement sensor 10 described with reference to FIGS. 1 to 9.

### First Embodiment

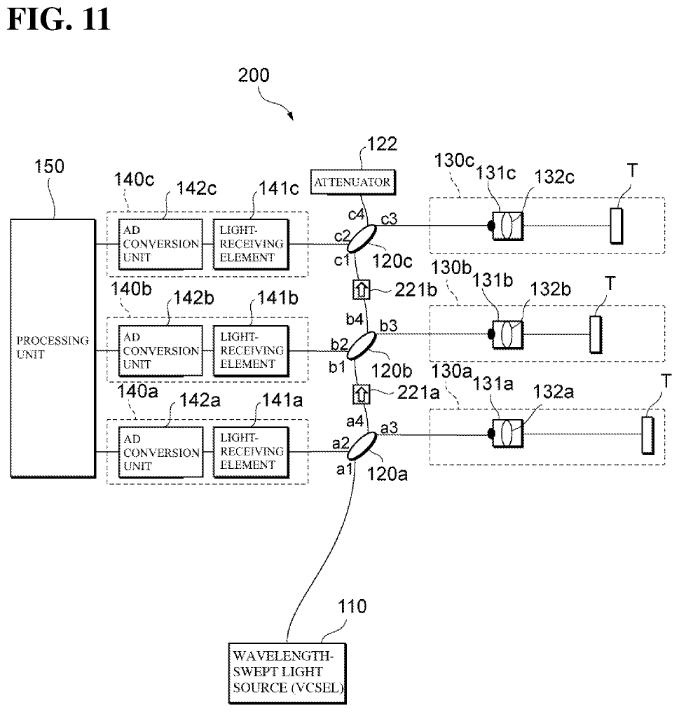

FIG. 10 is a schematic diagram showing an overview of a configuration of the optical interference range sensor 100 according to a first embodiment or embodiments. As shown in FIG. 10, the optical interference range sensor 100 includes a wavelength-swept light source 110, optical couplers 120a to 120c, an attenuator 122, interferometers 130a to 130c, light-receiving units 140a to 140c, and a processing unit 150. Note that the optical couplers 120a to 120c are also referred to simply as optical couplers 120 when they need not be distinguished from each other. The interferometers 130a to 130c are also referred to simply as interferometers 130 when they need not be distinguished from each other. The light-receiving units 140a to 140c are also referred to simply as light-receiving units 140 when they need not be distinguished from each other. The optical interference range sensor 100 shown in FIG. 10 is configured as a multi-stage optical interference range sensor, and is configured as an optical interference range sensor having a three-stage configuration with three interferometers, as an example. However, the number of interferometers (i.e., the number of stages) may alternatively be two, or may be four or more.

The wavelength-swept light source 110 is connected to a first port al of the optical coupler 120 directly or indirectly via another member (optical amplifier 52, isolator 53, optical coupler 54 etc.), and projects a light beam while continuously varying the wavelength.

The optical couplers 120a to 120c are connected to each other in series to form a three-stage configuration. In other words, the optical coupler 120a forms a first stage corresponding to the interferometer 130a, the optical coupler 120b forms a second stage corresponding to the interferometer 130b, and the optical coupler 120c forms a third stage corresponding to the interferometer 130c.

Each optical coupler 120 has 2×2 (four) ports. A light beam input to a port at one end is output to two ports at the other end at a predetermined split ratio. Specifically, the first-stage optical coupler 120a has a first port a1, a second port a2, a third port a3, and a fourth port a4. A light beam input to the first port al or the second port a2 is output to the third port a3 and the fourth port a4 at a predetermined split ratio. A light beam input to the third port a3 or the fourth port a4 is output to the first port al and the second port a2 at a predetermined split ratio.

The second-stage optical coupler 120b has a first port b1, a second port b2, a third port b3, and a fourth port b4. A light beam input to the first port b1 or the second port b2 is output to the third port b3 and the fourth port b4 at a predetermined split ratio. A light beam input to the third port b3 or the fourth port b4 is output to the first port b1 and the second port b2 at a predetermined split ratio.

The third-stage optical coupler 120c has a first port c1 a second port c2, a third port c3, and a fourth port c4. A light beam input to the first port c1 or the second port c2 is output to the third port c3 and the fourth port c4 at a predetermined split ratio. A light beam input to the third port c3 or the fourth port c4 is output to the first port c1 and the second port c2 at a predetermined split ratio.

The first port al of the first-stage optical coupler 120a is connected to the wavelength-swept light source 110, and directly or indirectly receives input of a light beam whose wavelength continuously varies, from the wavelength-swept light source 110.

The first-stage optical coupler 120a splits the light beam input from the wavelength-swept light source 110 to the first port al at a predetermined split ratio and outputs the split light beams to the third port a3 and the fourth port a4. The light beam output from the third port a3 of the first-stage optical coupler 120a is input to the first-stage interferometer 130a. The light beam output from the fourth port a4 of the first-stage optical coupler 120a is input to the first port b1 of the second-stage optical coupler 120b.

The second-stage optical coupler 120b splits the light beam input from the first-stage optical coupler 120a to the first port b1 at a predetermined split ratio and outputs the split light beams to the third port b3 and the fourth port b4. The light beam output from the third port b3 of the second-stage optical coupler 120b is input to the second-stage interferometer 130b. The light beam output from the fourth port b4 of the second-stage optical coupler 120b is input to the first port c1 of the third-stage interferometer 120c.

The third-stage optical coupler 120c splits the light beam input from the second-stage optical coupler 120b to the first port c1 at a predetermined split ratio and outputs the split light beams to the third port c3 and the fourth port c4. The light beam output from the third port c3 of the third-stage optical coupler 120c is input to the third-stage interferometer 130c. The light beam output from the fourth port c4 of the third-stage optical coupler 120c is input to the attenuator 122.

The interferometers 130a to 130c have respective sensor heads 131a to 131c. The sensor heads 131a to 131c have respective objective lenses 132a to 312c. Note that the sensor heads 131a to 131c may also have respective collimating lenses arranged between leading ends of optical fiber cables and the objective lenses 132a to 132c.

The light beam input from the third port a3 of the first-stage optical coupler 120a to the first-stage interferometer 130a is input to the sensor head 131a via an optical fiber cable. A part of the light beam input to the sensor head 131a is radiated as a measurement beam toward a measurement target T via the objective lens 132a, and is reflected at the measurement target T. The measurement beam reflected at the measurement target T is input to the sensor head 131a by being focused by the objective lens 132a in the sensor head 131a. Another part of the light beam input to the sensor head 131a serves as a reference beam and is reflected at a reference surface provided at the leading end of the optical fiber cable. As a result of the measurement beam and the reference beam interfering with each other on the reference surface of the sensor head 131a, a first interference beam corresponding to an optical path length difference between the measurement beam and the reference beam is generated. The first interference beam is output from the interferometer 130a and input to the third port a3 of the optical coupler 120a.

The light beam input from the third port b3 of the second-stage optical coupler 120b to the second-stage interferometer 130b is input to the sensor head 131b via an optical fiber cable. A part of the light beam input to the sensor head 131b is radiated as a measurement beam toward a measurement target T via the objective lens 132b, and is reflected at the measurement target T. The measurement beam reflected at the measurement target T is input to the sensor head 131b by being focused by the objective lens 132b in the sensor head 131b. Another part of the light beam input to the sensor head 131b serves as a reference beam and is reflected at a reference surface provided at the leading end of the optical fiber cable. As a result of the measurement beam and the reference beam interfering with each other on the reference surface of the sensor head 131 b, a second interference beam corresponding to an optical path length difference between the measurement beam and the reference beam is generated. The second interference beam is output from the interferometer 130b and input to the third port b3 of the optical coupler 120b.

The light beam output from the third port c3 of the third-stage optical coupler 120c is input to the sensor head 131c via an optical fiber cable. A part of the light beam input to the sensor head 131c is radiated as a measurement beam toward a measurement target T via the objective lens 132c, and is reflected at the measurement target T. The measurement beam reflected at the measurement target T is input to the sensor head 131c by being focused by the objective lens 132c in the sensor head 131c. Another part of the light beam input to the sensor head 131c serves as a reference beam and is reflected at a reference surface provided at the leading end of the optical fiber cable. As a result of the measurement beam and the reference beam interfering with each other on the reference surface of the sensor head 131c, a third interference beam corresponding to an optical path length difference between the measurement beam and the reference beam is generated. The third interference beam is output from the interferometer 130c and input to the third port c3 of the optical coupler 120c.

The attenuator 122 attenuates the light beam input from the fourth port c4 of the optical coupler 120c to reduce the reflected beam proceeding to the optical coupler 120c. The effect of phase noise can thus be reduced by reducing the reflected beam, and the optical interference range sensor 100 can measure the distance to the measurement target T with higher accuracy.

The optical element connected to an end of the optical fiber cable connected to the optical coupler 120c is not limited to the attenuator 122, and may alternatively be any other type of optical element. For example, an isolator may alternatively be connected, or the fiber leading end of the optical fiber cable may be processed and a coreless fiber or the like may be applied. In these cases as well, it is favorable to reduce the aforementioned effect of the phase noise by reducing the reflected beam proceeding to the optical coupler 120c by applying fusion connection, APC polishing, or the like.

The light-receiving units 140a to 140c have respective light-receiving elements 141a to 141c and AD conversion units 142a to 142c. The light-receiving elements 141a to 141c are photodetectors, for example, receive light beams output from the second ports a2 to c2 of the respective optical couplers 120a to 120c, and convert the received light beams to electrical signals. The AD conversion units 142a to 142c convert these electrical signals from analog signals to digital signals.

The light-receiving units 140a to 140c correspond to the optical couplers 120a to 120c, respectively, and receive light beams output from the second ports a2 to c2 of the respective optical couplers 120a to 120c.

As mentioned above, the first interference beam generated by the first-stage interferometer 130a is output from the interferometer 130a and input to the third port a3 of the optical coupler 120a. The first-stage optical coupler 120a then splits the first interference beam input to the third port a3 into light beams proceeding to the first port al and the second port a2 at a predetermined split ratio, and outputs the split light beams. The light-receiving unit 140a receives the light beam output from the second port a2 of the optical coupler 120a, generates a digital signal from the received light beam, and supplies the generated digital signal to the processing unit 150.

As mentioned above, the second interference beam generated by the second-stage interferometer 130b is output from the interferometer 130b and input to the third port b3 of the optical coupler 120b. The second-stage optical coupler 120b then splits the second interference beam input to the third port b3 into light beams proceeding to the first port b1 and the second port b2 at a predetermined split ratio, and outputs the split light beams. The light-receiving unit 140b receives the light beam output from the second port b2 of the optical coupler 120b, generates a digital signal from the received light beam, and supplies the generated digital signal to the processing unit 150.

As mentioned above, the third interference beam generated by the third-stage interferometer 130c is output from the interferometer 130c and input to the third port c3 of the optical coupler 120c. The third-stage optical coupler 120c then splits the third interference beam input to the third port c3 into light beams proceeding to the first port c1 and the second port c2 at a predetermined split ratio, and outputs the split light beams. The light-receiving unit 140c receives the light beam output from the second port c2 of the optical coupler 120c, generates a digital signal from the received light beam, and supplies the generated digital signal to the processing unit 150.

The processing unit 150 calculates the distance to the measurement target T based on the digital signals converted by the light-receiving units 140a to 140c. For example, the processing unit 150 is a processor implemented by an integrated circuit such as an FPGA, and performs frequency conversion on the input digital signals by means of FFT and calculates the distance to the measurement target T based on the frequency conversion results.

The optical interference range sensor 100 according to a first embodiment or embodiments includes a suppressing unit that suppresses a supply of light beams from the downstream side to the upstream side in the plurality of stages of optical couplers 120. Particularly, the optical interference range sensor 100 according to a first embodiment or embodiments includes, as the suppressing unit, the optical couplers 120 each of which causes the amount of light of a light beam that is split and proceeds to the next stage to be larger than the amount of light of a light beam that is split and proceeds to the corresponding interferometer 130. For example, the first-stage optical coupler 120a is an example of a suppressing unit, and the ratio between the amount of light of the light beam that is split and proceeds to the corresponding interferometer 130a and the amount of light of the light beam that is split and proceeds to the next stage (second-stage optical coupler 120b) may be 10:90. Also, for example, the second-stage optical coupler 120b is an example of the suppressing unit, and the ratio between the amount of light of the light beam that is split and proceeds to the corresponding interferometer 130b and the amount of light of the light beam that is split and proceeds to the next stage (third-stage optical coupler 120c) may be 15:85. Also the third-stage optical coupler 120c is an example of the suppressing unit, and the ratio between the amount of light of the light beam that is split and proceeds to the corresponding interferometer 130c and the amount of light of the light beam that is split and proceeds to the next stage (attenuator 122) may be 20:80. The supply of light beams from the downstream side to the upstream side is thus suppressed in the plurality of stages of optical couplers. As a result, the measurement accuracy of the optical interference range sensor can be improved by suppressing return beams from the next-stage couplers to the previous-stage couplers.

In the optical interference range sensor 100 according to a first embodiment or embodiments, a setting may be configured so that an optical coupler 120 located farther away from the wavelength-swept light source 110 has a relative higher ratio of the amount of light of a light beam that is split and proceeds to a corresponding interferometer 130. In other words, when i denotes the number of stages of the optical couplers 120 included in the optical interference range sensor 100 (i is one of the natural numbers of 1 to n, where n is the number of stages of the optical couplers 120 included in the optical interference range sensor 100), and Ri denotes the split ratio, i.e., the proportion of the amount of light of the light beam that is split and proceeds to the corresponding interferometer 130 to the amount of light of the light beam that is split and proceeds to the next stage for the ith-stage optical coupler 120, a setting may be configured so that the expression Rᵢ₊₁≥Rᵢ is satisfied. For example, in the above example, R₁ is 10/90, R₂ is 15/85, and R₃ is 20/80. Therefore, R₃≥R₂≥R₁ is satisfied, and Rᵢ₊₁≥Rᵢ is satisfied (lere, i=1, 2, 3). As a result, a variation in the amount of light received by the interferometers is reduced, thus making is possible to improve the measurement accuracy of the optical interference range sensor.

In the optical interference range sensor 100 according to a first embodiment or embodiments, whin L_{CR,i} denotes the optical path length from the ith-stage optical coupler 120 to the reference surface of the corresponding interferometer 130, Ind L_{CC,i} denotes the optical path length from the ith-stage optical coupler 120 to the i+1th-stage optical coupler 120, a setting may be configured so tlat |L_{CR,i}−(L_{CR,i+1}+L_{CC,i})| is not smaller than a predetermined threshold (first threshold) (where “∥” indicates an absolute value). Note that both optical path lelgths L_{CR,i} and L_{CC,i} may have values obtained by multiplying the spatial length of the optical path by the refractive index. Thus, interference between a plurality of interference beams generated by the plurality of interferometers is suppressed, thus making it possible to improve the measurement accuracy of the optical interference range sensor.

Particularly, the aforementioned threshold (first thresholl) for L_{CR,i}−(L_{CR,i+1}+L_{CC,i}) may be determined based on the frequency band of the light-receiving units 140. Thus, interference between the plurality of interference beams can be effectively suppressed in accordance with the frequency band of the light-receiving units, thus making it possible to improve the measurement accuracy of the optical interference range sensor.

### Second Embodiment

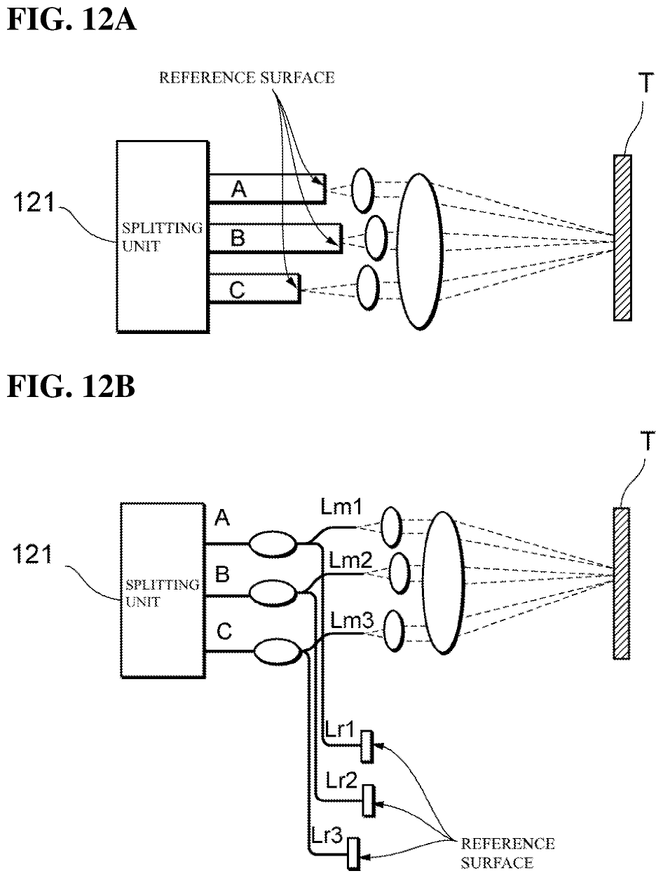

FIG. 11 is a schematic diagram showing an overview of a configuration of the optical interference range sensor 200 according to a second embodiment or embodiments. The optical interference range sensor 200 according to a second embodiment or embodiments includes isolators 221a and 221b in addition to the constituent elements included in the above-described optical interference range sensor 100 according to a first embodiment or embodiments.

Each of the isolators 221a and 221b is an example of the suppressing unit that suppresses the supply of light beams from the next stage to the previous stage, out of the plurality of stages of optical couplers, and is, particularly, an example of a cut-off unit configured to guide light beams from the previous-stage optical couplers to the next-stage optical couplers but not to guide light beams from the next-stage optical couplers to the previous-stage optical couplers. As will be described later in detail, the isolators 221a and 221b are configured to guide light beams from the previous-stage optical couplers 120 to the next-stage optical couplers but not to guide light beams from the next-stage optical couplers to the previous stage optical couplers. Thus, return beams from the next-stage optical couplers to the previous-stage optical couplers can be suppressed, thus making it possible to improve the measurement accuracy of the optical interference range sensor.

The isolator 221a is optically connected between the fourth port a4 of the first-stage optical coupler 120a and the first port b1 of the second-stage optical coupler 120b. The isolator 221a is configured to guide a light beam from the first-stage optical coupler 120a to the second-stage optical coupler 120b, but not to guide a light beam from the second-stage optical coupler 120b to the first-stage optical coupler 120a. Accordingly, the isolator 221a cuts out the light beam that is output from the first port b1 and proceeds toward the first-stage optical coupler 120a, of the second interference beam that is input from the third port b3 to the optical coupler 120b, as mentioned above.

The isolator 221b is optically connected between the fourth port b4 of the second-stage optical coupler 120b and the first port c1 of the third-stage optical coupler 120c. The isolator 221b is configured to guide a light beam from the second-stage optical coupler 120b to the third-stage optical coupler 120c, but not to guide a light beam from the third-stage optical coupler 120c to the second-stage optical coupler 120b. Therefore, the isolator 221b cuts off the light beam that is output from the first port c1 and proceeds toward the second-stage optical coupler 120b, of the third interference beam that is input from the third port c3 to the optical coupler 120c, as mentioned above.

Reflected beams may be generated from the isolators 221a and 221b toward the previous-stage optical couplers 120, and these reflected beams can further interfere with the interference beams received by the previous-stage optical couplers 120 from the corresponding interferometers 130. The optical interference range sensor 200 according to a second embodiment or embodiments may be set as follows, for example, to suppress interference between the reflected beams coming from the isolators 221a and 221b and proceeding toward the previous-stage optical couplers 120 and the interference beams generated by the interferometers 130. That il, when L_{CR,i} denotes the optical path length from the ith-stage optical coupler to the corresponding interferomeler, and L_{CI,i} denotes the optical path length from the ith-stage optical coupler to a next-stage isolator connected to the ith-stage optical coupler, a setting may be configured so that |LCR,i−L_{CI,i}| is not smaller than a predetermined threshold (second threshold). Note that both optical patl lengths L_{CR,i} and L_{CI,i} may have values obtained by multiplying the spatial length of the optical path by the refractive index. Thus, interference between the reflected beams from the isolators (cut-off units) and the interference beams generated by the interferometers is suppressed, making it possible to improve the measurement accuracy of the optical interference range sensor.

Particularly, the aforementioned threshold (second threslold) for |LCR,i−L_{CI,i}| may be determined based on the frequency band of the light-receiving units 140. Thus, it is possible to effectively suppress interference between the reflected beams from the isolators (cut-off units) and the interference beams generated by the interferometers in accordance with the frequency band of the light-receiving units, and to improve the measurement accuracy of the optical interference range sensor.

### Variation of Interferometer

In the above described embodiments, the optical interference range sensor 100 uses Fizeau interferometers that generate reference beams by using, as reference surfaces, the leading ends of the optical fiber cables in the interferometers 130a to 130b. However, the interferometers are not limited thereto.

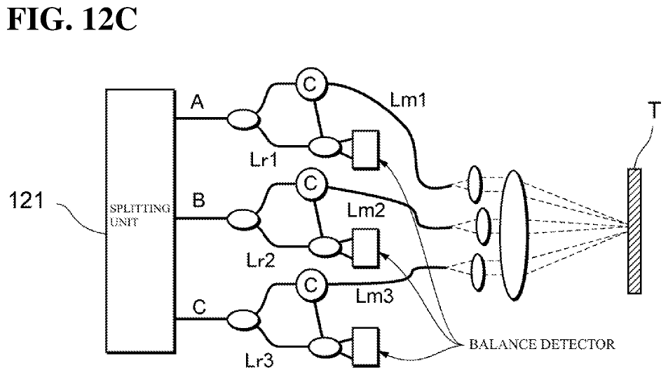

FIGS. 12A to 12C show variations of interferometers that generate an interference beam using a measurement beam and a reference beam. In FIG. 12A, the leading end positions of the optical fiber cables are shifted in the optical axis direction so that the optical path length difference is different among the optical paths A to C split by the splitting unit 121, while using the leading end (end face) of each optical fiber cable as a reference surface. The illustrated arrangement is the configuration of the interferometer 120 (Fizeau interferometer) of the optical interference range sensor 100 according to the above described embodiment or embodiments. The reference surface may alternatively be configured so that a light beam is reflected due to a difference in refractive index between the optical fiber cable and the air (Fresnel reflection). In addition, the leading end of each optical fiber may also be coated with a reflective film. Alternatively, a configuration may also be employed in which a non-reflective coating is applied to the leading end of each optical fiber, and a reflective surface, such as a lens surface, is arranged separately.

In FIG. 12B, measurement optical paths Lm1 to Lm3 for guiding measurement beams to the measurement target T and reference optical paths Lr1 to Lr3 for guiding reference beams are formed in the optical paths A to C split by the splitting unit 121. Reference surfaces are arranged at leading ends of the reference optical paths Lr1 to Lr3 (Michelson interferometer). The reference surfaces may be obtained by coating the leading ends of the optical fiber cables with reflective films, or may be obtained by applying non-reflective coating to the leading ends of the optical fibers and separately arranging reflective surfaces such as lens surfaces. In the illustrated configuration, the measurement optical paths Lm1 to Lm3 have the same optical path length, while the optical path length difference is provided between the reference optical paths Lr1 to Lr3, thereby making the optical path length difference different among the optical paths A to C. Optical design in the sensor head can be simplified since the optical path lengths of the measurement optical paths Lm1 to Lm3 can be made identical.

In FIG. 12C, measurement optical paths Lm1 to Lm3 for guiding measurement beams to the measurement target T and reference optical paths Lr1 to Lr3 for guiding reference beams are formed in the optical paths A to C split by the splitting unit 121. Balance detectors are arranged in the reference optical paths Lr1 to Lr3 (Mach-Zehnder interferometer). In the illustrated configuration, the measurement optical paths Lm1 to Lm3 have the same optical path length, while the optical path length difference is provided between the reference optical paths Lr1 to Lr3, thereby making the optical path length difference different among the optical paths A to C. Optical design in the sensor head can be simplified since the optical path lengths of the measurement optical paths Lm1 to Lm3 can be made identical.

Thus, the interferometer is not limited to the Fizeau interferometer in the embodiment or embodiments described above, and may be, for example, a Michelson interferometer or a Mach-Zehnder interferometer. Any type of interferometer may be applied, or a combination of those interferometers or any other configuration may be applied if an interference beam can be generated by setting the optical path length difference between a measurement beam and a reference beam.

### LIST OF REFERENCE NUMERALS

1 Sensor system
10 Displacement sensor
11 Control device
12 Control signal input sensor
13 Externally connected device
20 Sensor head
21 Objective lens
22, 22a to 22c Collimating lens
23 Objective lens holder
24, 24a to 24c Collimating lens unit
30 Controller
31 Display unit
32 Setting unit
33 External interface (I/F) unit
34 Optical fiber cable connector
35 External storage unit
36 Measurement processing unit
40 Optical fiber cable
51 Wavelength-swept light source
52 Optical amplifier
53, 53a to 53b Isolator
54, 54a to 54j Optical coupler
55 Attenuator
56a to 56c Light-receiving element
57 Multiplexer circuit
58 AD conversion unit
59 Processing unit
60 Balance detector
61 Correction signal generation unit
71a to 71e Light-receiving element
72a to 72c Amplifier circuit
73 Multiplexer circuit
74 AD conversion unit
75 Processing unit
76 Differential amplifier circuit
77 Correction signal generation unit
100 Optical interference range sensor
110 Wavelength-swept light source
120a to 120c Optical coupler
122 Attenuator
130a to 130c Interferometer
131a to 131c Sensor head
132a to 132c Objective lens
140a to 140c Light-receiving unit
141a to 141c Light-receiving element
142a to 142c AD conversion unit
150 Processing unit
221a, 221b Isolator
a1 to a4, b1 to b4, c1 to c4 Port of optical coupler
T Measurement target
Lm1 to Lm3 Measurement optical path
Lr1 to Lr3 Reference optical path

1. An optical interference range sensor comprising:
a light source configured to project a light beam while continuously varying a wavelength thereof;
a plurality of interferometers each configured to generate an interference beam by interference between a measurement beam reflected at a measurement target as a result of a supplied light beam being guided to the measurement target and a reference beam passing through an optical path that is at least partially different from an optical path of the measurement beam;
a plurality of stages of optical couplers connected in series, each of the plurality of stages of optical couplers being configured to receive, from an upstream side, the light beam from the light source, split the received light beam into a beam proceeding to a corresponding interferometer, of the plurality of interferometers, and a beam proceeding to a downstream side, and supply the split light beams;
a suppressing unit comprising at least one optical coupler or isolator configured to suppress a supply of a light beam from the downstream side to the upstream side in the plurality of stages of optical couplers; and
a processor configured to calculate a distance to the measurement target based on frequencies of a plurality of interference beams generated by the plurality of interferometers.

2. The optical interference range sensor according to claim 1,
wherein the suppressing unit comprises at least one optical coupler out of the plurality of stages of optical couplers, the at least one optical coupler being configured to cause an amount of light of a light beam that is split and proceeds to the downstream stage to be larger than an amount of light of a light beam that is split and proceeds to the corresponding interferometer.

3. The optical interference range sensor according to claim 1,
wherein a proportion, denoted by Rᵢ, of an amount of light of a light beam that is split and proceeds to the corresponding interferometer to an amount of light of a light beam that is split and proceeds to the downstream side, regarding an ith-stage optical coupler out of the plurality of stages of optical couplers, is set such that the expression Rᵢ₊₁≥Rᵢ is satisfied.

4. The optical interference range sensor according to claim 1,
wherein each of the plurality of interferometers generates the respective interference beam by interference between a first reflected beam that is a reflected beam of the measurement beam radiated toward the measurement target and reflected at the measurement target and a second reflected beam that is a reflected beam of the reference beam reflected at a reference surface.

5. The optical interference range sensor according to claim 4,
wherein an optical path length, denoted by L_{CR,i}, from an ith-stage optical coupler to a reference surface in a corresponding interferometer of the plurality of interferometers and an optical path length, denoted by L_{CC,i}, from the ith-stage optical coupler to an i+1th-stage optical coupler are set such that the Ix—ression |L_{CR,i}−(L_{CR,i+1}+L_{CC,i})| is not smaller than a first threshold.

6. The optical interference range sensor according to claim 5,
wherein the first threshold is set based on a frequency band of a light-receiving unit configured to convert the plurality of interference beams into electrical signals and supply the electrical signals to the processor.

7. The optical interference range sensor according to claim 4,
wherein the suppressing unit comprises an isolator connected between two optical couplers out of the plurality of stages of optical couplers and configured to guide a light beam from a previous-stage optical coupler to a next-stage optical coupler and not to guide a light beam from the next-stage optical coupler to the previous-stage optical coupler.

8. The optical interference range sensor according to claim 7,
wherein an optical path length, denoted by L_{CR,i} from an ith-stage optical coupler to a reference surface in a corresponding interferometer and an optical path length, denoted by L_{CI,i}, from the ith-stage optical coupler to the isolator connected thereto on a downstream side are set such that the expression |L_{CR,i}−L_{CI,i}| is not smaller than a second threshold.

9. The optical interference range sensor according to claim 8,
wherein the second threshold is set based on a frequency band of a light-receiving unit configured to convert the plurality of interference beams into electrical signals and supply the electrical signals to the processor.

10. The optical interference range sensor according to claim 2,
wherein a proportion, denoted by Rᵢ, of an amount of light of a light beam that is split and proceeds to the corresponding interferometer to an amount of light of a light beam that is split and proceeds to the downstream side, regarding an ith-stage optical coupler out of the plurality of stages of optical couplers, is set such that the expression Rᵢ₊₁≥Rᵢ is satisfied.

11. The optical interference range sensor according to claim 2,
wherein each of the plurality of interferometers generates the respective interference beam by interference between a first reflected beam that is a reflected beam of the measurement beam radiated toward the measurement target and reflected at the measurement target and a second reflected beam that is a reflected beam of the reference beam reflected at a reference surface.

12. The optical interference range sensor according to claim 3,
wherein each of the plurality of interferometers generates the respective interference beam by interference between a first reflected beam that is a reflected beam of the measurement beam radiated toward the measurement target and reflected at the measurement target and a second reflected beam that is a reflected beam of the reference beam reflected at a reference surface.

13. The optical interference range sensor according to claim 5,
wherein the suppressing unit comprises an isolator connected between two optical couplers out of the plurality of stages of optical couplers and configured to guide a light beam from a previous-stage optical coupler to a next-stage optical coupler and not to guide a light beam from the next-stage optical coupler to the previous-stage optical coupler.

14. The optical interference range sensor according to claim 6,
wherein the suppressing unit comprises an isolator connected between two optical couplers out of the plurality of stages of optical couplers and configured to guide a light beam from a previous-stage optical coupler to a next-stage optical coupler and not to guide a light beam from the next-stage optical coupler to the previous-stage optical coupler.

15. The optical interference range sensor according to claim 11,
wherein the suppressing unit comprises an isolator connected between two optical couplers out of the plurality of stages of optical couplers and configured to guide a light beam from a previous-stage optical coupler to a next-stage optical coupler and not to guide a light beam from the next-stage optical coupler to the previous-stage optical coupler.

16. The optical interference range sensor according to claim 12,
wherein the suppressing unit comprises an isolator connected between two optical couplers out of the plurality of stages of optical couplers and configured to guide a light beam from a previous-stage optical coupler to a next-stage optical coupler and not to guide a light beam from the next-stage optical coupler to the previous-stage optical coupler.
